(19) United States
(12) Patent Application Publication
(10) Pub. No.: US 2014/0180861 A1
(43) Pub. Date: Jun. 26, 2014

(54) METHODS AND SYSTEMS FOR COLLABORATIVE BUNDLING

(71) Applicant: Chandrashekar Basavaiah, San Ramon, CA (US)

(72) Inventor: Chandrashekar Basavaiah, San Ramon, CA (US)

(73) Assignee: eBay Inc., San Jose, CA (US)

(21) Appl. No.: 13/725,851

(22) Filed: Dec. 21, 2012

(51) Int. Cl. G06Q 30/06

(52) U.S. Cl. CPC G06Q 30/0605
USPC 705/26.2

(57) ABSTRACT

A method and a system for collaborative bundling of items in an online marketplace are provided. For example, a first identification of a first item for sale in an online marketplace and an indication of availability to bundle may be received from a client device. Based on the indication of availability to bundle, an identification interface that presents identifications of one or more items suitable for bundling with the first item may be provided to the client device. A selection of a second identification of a second item may be received. The second identification may be selected from the identifications of the one or more items. A negotiation within the online marketplace pertaining to a bundling of the first and second items may be facilitated. A bundle listing including the first identification of the first item and the second identification of the second item may be generated based on the negotiation.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### TECHNICAL FIELD

The present application relates generally to the technical field of data processing and, in one specific example, to methods and systems for collaborative bundling.

### BACKGROUND

Buyers and sellers may engage in transactions to exchange goods and services using an online marketplace. A seller may offer a number of his or her items for sale as a bundle. In some instances, a seller may offer a discount to a buyer who will purchase two or more of the seller's products.

### BRIEF DESCRIPTION OF THE DRAWINGS

Some embodiments are illustrated by way of example and not limitation in the figures of the accompanying drawings in which:

FIG. 1 is a network diagram depicting a client-server system, within which various example embodiments may be deployed.

FIG. 2 is a block diagram of a bundling component, according to various example embodiments.

FIG. 3 is a flowchart illustrating an example of a collaborative bundling method, according to various example embodiments.

FIGS. 4A and 4B are example portions of user interfaces for collaborative bundling, according to various example embodiments.

FIG. 5 is an example portion of a user interface for collaborative bundling, according to various example embodiments.

FIG. 6 is an example portion of a user interface for negotiation of terms during a collaborative bundling process, according to various example embodiments.

FIG. 7 is an example portion of a user interface for negotiation of terms during a collaborative bundling process, according to various example embodiments.

FIG. 8 is an example portion of a user interface for providing a collaborative bundle, according to various example embodiments.

FIG. 9 is a diagrammatic representation of machine in the example form of a computer system within which a set of instructions, for causing the machine to perform any one or more of the methodologies discussed herein, may be executed.

### DETAILED DESCRIPTION

Example methods and systems for collaborative bundling are described. In the following description, for purposes of explanation, numerous specific details are set forth in order to provide a thorough understanding of example embodiments. It will be evident, however, to one skilled in the art that the present invention may be practiced without these specific details.

The subject matter described herein may allow two or more users (e.g., sellers) to negotiate within an online marketplace a bundling agreement to sell items provided by each of the users as part of a bundle. As used herein, the term “item” may refer to a good or a service. The good or service may be described in a product or service catalogue (e.g., using an identification, name, number, definition, or other identifier). In some example embodiments, a user may be a human being. In certain example embodiments, a user may be a business entity that provides items for sale.

By combining items in a bundle, additional value may be provided to a buyer of the bundle (e.g., a better price or saved time). Also, the sellers may benefit from bundling items with other sellers, for example, by selling items faster or selling items at a higher margin. Furthermore, by associating with another seller with a higher reputation a trusted seller or a best seller) to sell a bundle, a seller may be able to indirectly benefit from the other seller's reputation, for example, by having more users consider purchasing the bundle based on the higher reputation of the associate seller.

The system receives an indication of availability to bundle from a first user along with a listing describing an item for sale. In some example embodiments, the first user identifies a first item that is listed for sale within an online marketplace and indicates that the first item is available for bundling with other users' items for sale. In various example embodiments, the first user may indicate that all of the first user's items for sale on the online marketplace are available for bundling with other users' items. The identification of the first item or the indication of availability to bundle, or both, may be received, in certain example embodiments, from a bot (e.g., a software application that may run an automated task on behalf of the first user) based on a predefined rule provided or selected by the first user. Based on the indication of availability to bundle, the present system may present (e.g., in a user interface) additional items suitable for bundling with the identified first item. The additional items are listed for sale by other users in the online marketplace. In some example embodiments, the system may provide the additional items according to a predefined rule provided or selected by the first user. For example, the first user may specify in a rule that he or she prefers to create a bundle with a social network friend who has listed an item for sale. In some example embodiments, the first user may select a second item from the additional items. The second item is listed in the online marketplace by a second user. In other example embodiments, a bot may select the second item based on a predefined rule.

Based on the selection of the second item, the system may facilitate a negotiation between the two sellers to bundle the first and second items. In certain example embodiments, the system presents a negotiation interface to each user participating in the negotiation (e.g., the first user and the second user). The negotiation interface may also include negotiation terms that the users may adopt or modify according to their preference. In some example embodiments, the system automatically sends a list of terms that are part of a bundling agreement to the other users based on a bundle agreement provided by one of the users. The users may negotiate a one-time relationship and a one-time bundle. In some embodiments, a longer-term relationship is negotiated by the users.

Further, based on the negotiation, the system may generate a listing for the bundle that includes the first and second items. The bundle listing may be published within the online marketplace. In some example embodiments, the first item may be offered for sale as a single item and as part of a bundle.

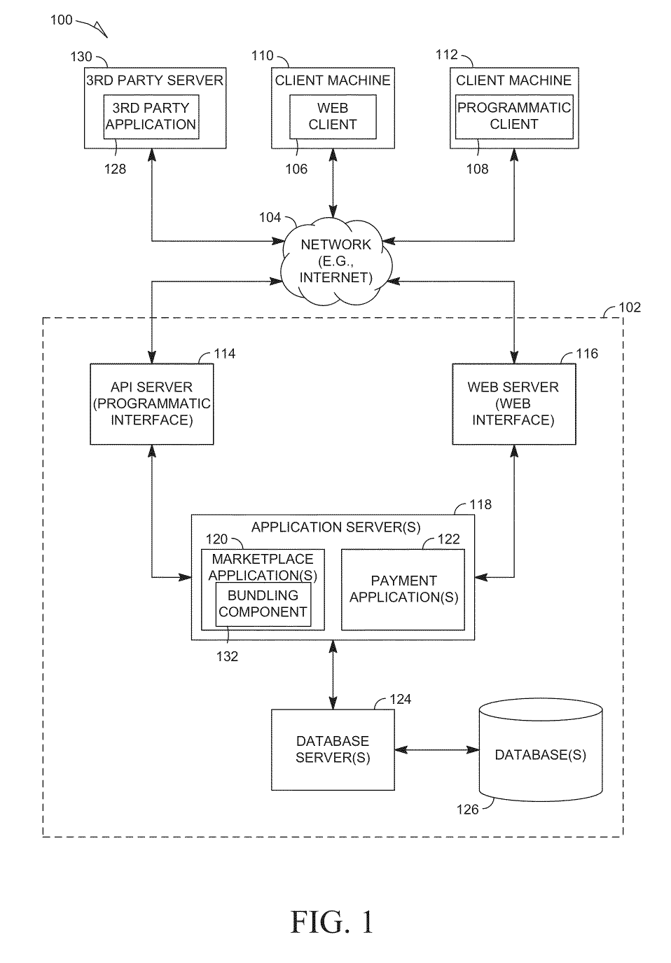

FIG. 1 is a network diagram depicting a client-server system 100, within which various example embodiments may be deployed. A networked system 102, in the example form of a network-based marketplace or publication system, provides server-side functionality, via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. In various example embodiments, the marketplace applications 120 may include a bundling component 132. The bundling component 132, in some example embodiments, may allow users to negotiate item bundles and offer the item bundles for sale using an online marketplace. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102. In various example embodiments, the seller application may allow users to negotiate a bundle of items provided by the users and to create a bundle listing (e.g., to be published using an online marketplace catalogue).

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

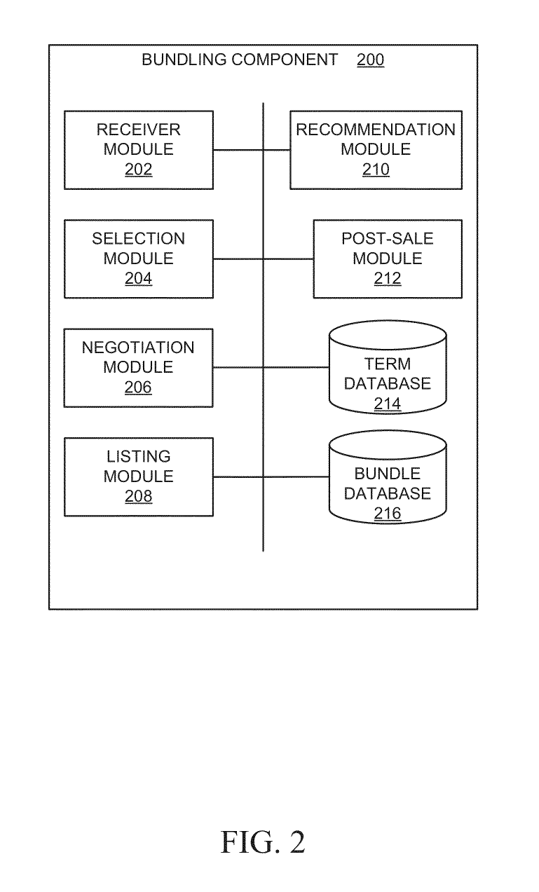

FIG. 2 is a block diagram of a bundling component, according to various example embodiments. In various example embodiments, the bundling component 200 may be included in the marketplace applications 120 as the bundling component 132. The bundling component 200 may be implemented in hardware, software, or a combination of hardware and software. In some example embodiments, the bundling component 200, has, or is implemented with, one or more processors. The bundling component 200 may receive input from a user via the web interface supported by the web server 116 or the programmatic interface supported by the API server 114.

The bundling component 200 may include a number of modules that may be in communication with each other. In FIG. 2, the bundling component 200 is shown as including a receiver module 202, a selection module 204, a negotiation module 206, a listing module 208, a recommendation module 210, a post-sale module 212, a term database 214, and a bundle database 216 configured to communicate with each other (e.g., via a bus, shared memory, or a switch).

A receiver module 202 is configured to receive from a client machine 110 or 112 (also referred to as a “client device”) a first identification of a first item listed for sale in an online marketplace by the user of the client machine 110 or 112 and an indication of availability to bundle. An identification of an item may be used to identify other items that may be bundled and offered for sale with the first item. In some example embodiments, the first identification or the indication of availability to bundle are received at the receiver module 202 as a result of a first user selecting an identification of an item listed for sale by the first user using the web client 106 or the programmatic client 108. For example, using a graphical user interface on the client machine 110 or 112, the first user may select the first item from a list of items offered for sale, and indicate (e.g., by selecting a checkbox) that the selected first item is available for bundling. In certain example embodiments, the first identification or the indication of availability to bundle, or both, is received at the receiver module 202 as a result of a software application (e.g., a programmatic client 108 or a bot) executing on the client machine 112.

In some example embodiments, the first identification of a the first item is an identifier of a product or service, such as a name, a trade name, a number, a stock-keeping unit (SKU) number, a universal product code (UPC) bar code, an international standard book number (ISBN), or other item identifier. The receiver module 202 may access a database (e.g., database 126) to compare the received first identification of the first item to a stored first identification of the first item. Based on receiving the indication of availability to bundle (e.g., the first item with other items provided by other users), in some example embodiments, the receiver module 202 may modify a record (e.g., in the database 126) that may store the first identification of the first item to indicate that the first item is available for bundling.

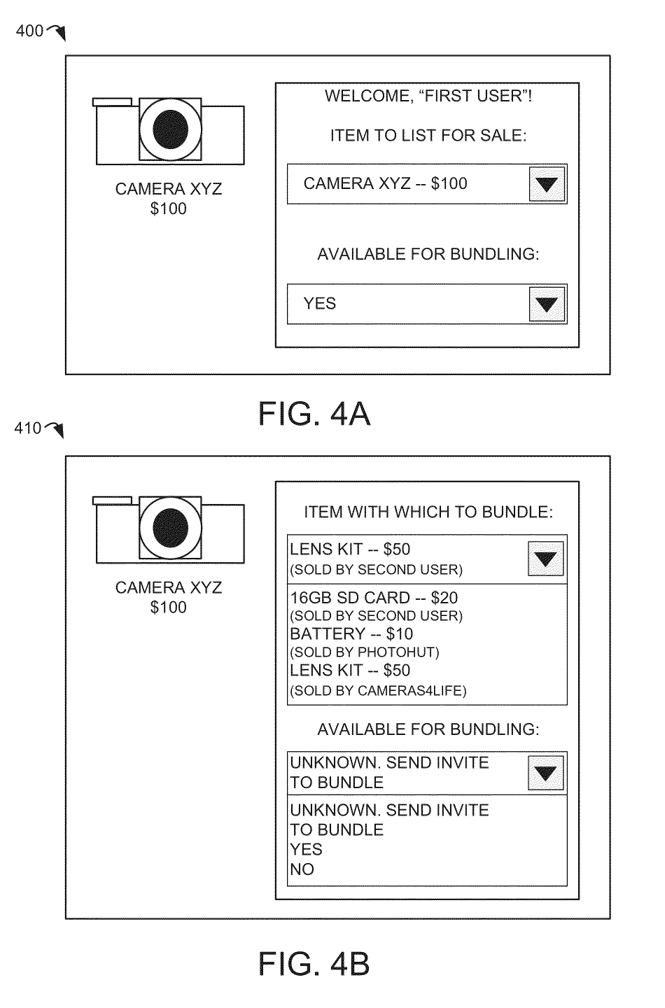

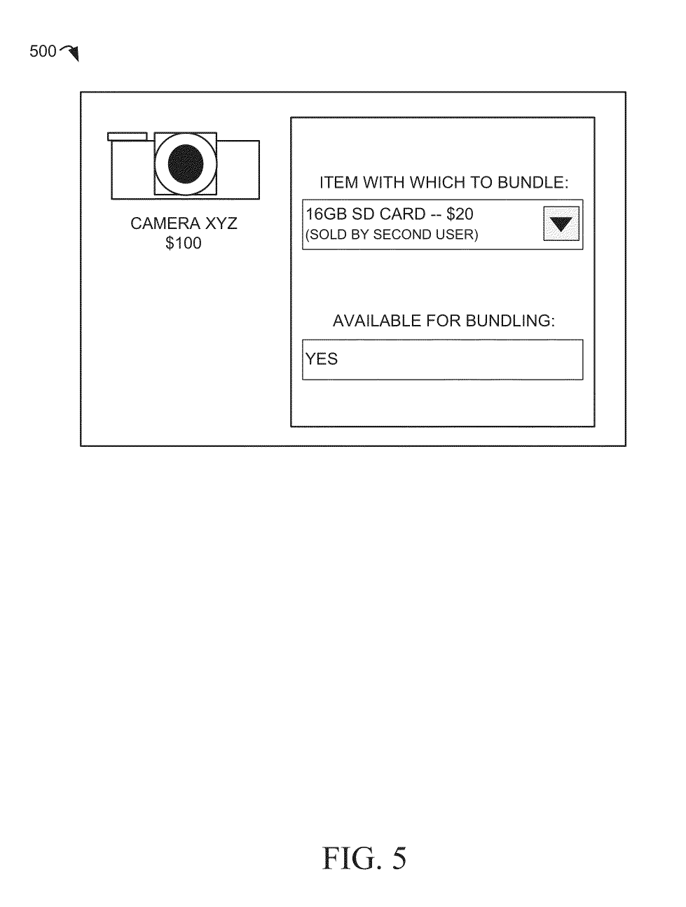

A selection module 204 is configured to, based on the indication of availability to bundle, provide to the client machine 110 or 112 an identification interface that presents identifications of one or more items suitable for bundling with the first item. The identifications may be provided by one or more other users. An example identification interface is described with respect to FIGS. 4A, 4B, and 5. In some example embodiments, the identification interface is a graphical user interface, displayed on a first user's device. The graphical user interface presents the identifications of the one or more items suitable for bundling with the first item. The first user may select (e.g., by clicking on) a second identification of a second item from a list of one or more items suitable for bundling with the first item.

The selection module 203 is configured to receive the selection of the second identification of the second item from the identifications of the one or more items. The selection may be made by the first user or on behalf of the first user (e.g., by a software application) based on a predefined rule. For example, the first user who is selling a photographic camera may specify in a rule that only photographic equipment that work with the respective photographic camera may be presented as suitable for bundling with the respective photographic camera.

The selection module 204 is further configured to determine a subset of the one or more items that are suitable for bundling with the first item for sale. The one or more items may be provided by one or more other users. In certain example embodiments, the selection module 204 may determine the subset of the one or more items based on an analysis of data that describes the first item (e.g., the identification, the name, or the description). The analysis may also be based on historical sales data (e.g., items purchased together with instances of the first item). Based on the selection module 204 determining the subset of the one or more items, the subset of the one or more items may be recommended (e.g., to the first user) by a recommendation module 210.

In some example embodiments, the subset may be determined based on the reputation of the one or more other users. For example, the first user may request (e.g., in a predefined rule) that only items of users with excellent selling reputation be selected when determining a subset of the one or more items suitable for bundling with the first user's first item.

In various example embodiments, the subset may be determined based on one or more bundle definitions. For example, the first user who is selling the first item (e.g., a camera) may define a bundle by specifying a second item (e.g., a type of lens that works with the camera).

In certain example embodiments, the subset may be determined based on a respective one or more items being listed for sale beyond a time threshold. For example, the selection module 204 may determine if any items provided by one or more other users have been listed for sale for longer than a specified period of time (e.g., more than 30 days) and may create a list of the determined items (e.g., the subset of the one or more items).

The selection module 204 is further configured to receive a ranking of the one or more identifications. The ranking indicates a preferred bundling order. In some example embodiments, the first user may rank the identifications using the identification interface provided by the selection module 204 to the client machine 110 or 112. In various example embodiments, the ranking is performed automatically (e.g., by a software application) based on a predefined rule. According to one example predefined rule, the identifications of the items more popular with buyers may be ranked higher than the identifications of the less popular items. The selection module 204 may store the received ranking in a record in the database 126.

In some example embodiments, the selection module 204 is further configured to receive a ranking of preferred bundling partners. For example, the identification of a second item provided by a second user may be ranked higher than the identification of a third item provided by a third user if the second user has a better seller reputation relative to the third user. In another example, the first user may rank members of the first user's family (or social network) higher than users who are strangers. The selection module 204 may store the received ranking in a record in the database 126.

A negotiation module 206 is configured to facilitate a negotiation within the online marketplace pertaining to a bundling of the first and second items. The negotiation may take place between the first user and a second user (e.g., a user of the one or more other users, who provided the second identification of the second item selected by the first user). In some example embodiments, the negotiation module 206 is configured to transmit an invitation to negotiate a bundle of the first and second items (e.g., to the second user based on the selection module 204 receiving the selection of the second identification of the second item). The invitation to negotiate may, in some instances, include bundling terms suggested (e.g., offered) by the first user. In some example embodiments, the second user may create a bundle of the first and second items by accepting the bundling terms suggested by the first user. In other example embodiments, the second user may accept the invitation to negotiate a bundle with the first user, but may not accept one or more of the terms suggested by the first user. The acceptance of the invitation to negotiate may trigger the transmittal of an indication (e.g., an instruction) to initiate the facilitation of a negotiation between the first and second users. In some example embodiments, the indication may be transmitted by the web client 106 or the programmatic client 108 of a client machine 110 or 112 (e.g., used by the second user to indicate the second user's acceptance of the invitation to negotiate a bundle). The indication may be received, in some instances, by the negotiation module 206.

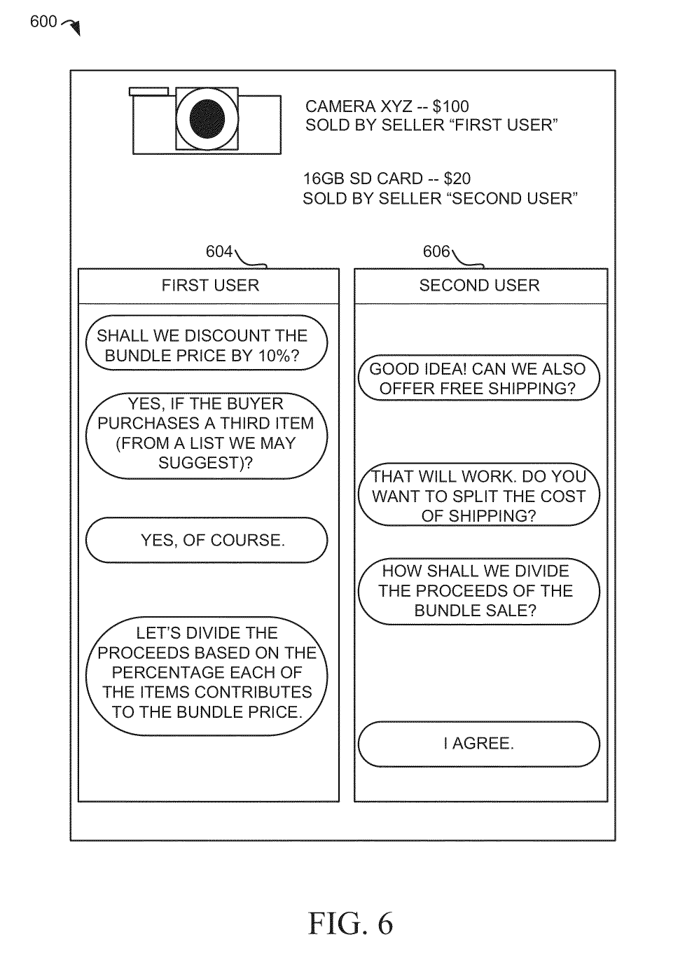

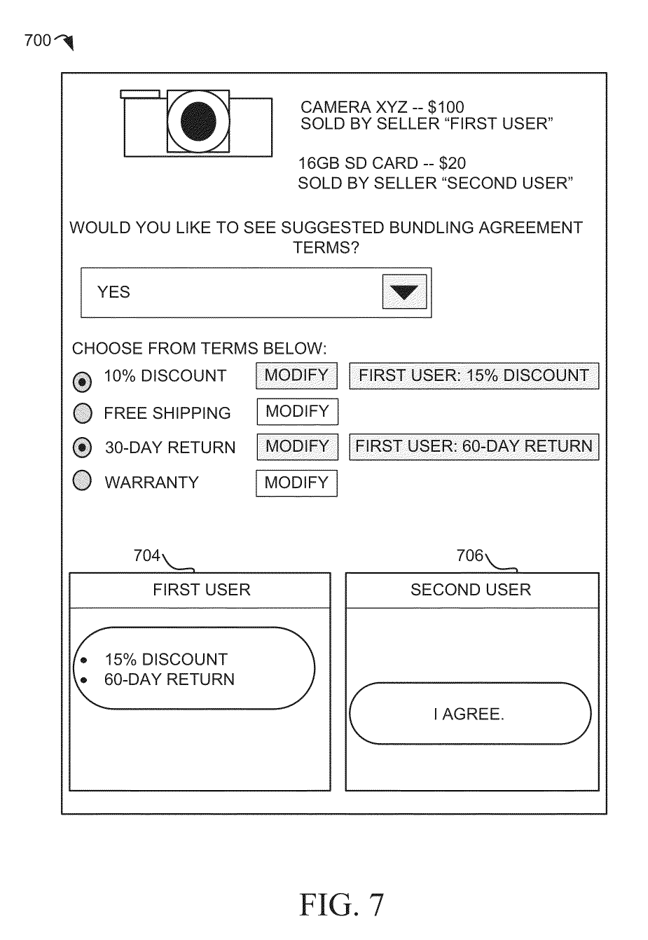

In certain example embodiments, the negotiation module 206 is further configured, based on receiving an instruction to initiate the negotiation, to access (e.g., in a term database 214) terms included in a bundling agreement. The terms may be part of a default bundling agreement. In some example embodiments, the terms may be provided by the first user. Examples of terms may be a bundle price, a discount, shipping and handling fees, a return policy, a warranty, and a sharing of sales proceeds. The term database 214 may be accessed by one or more modules of the bundling component 200 to either retrieve or store data, or both. The negotiation module 206 may also provide a negotiation interface including the accessed terms. An example negotiation interface is further described with respect to FIGS. 6 and 7.

The first user or the second user may modify one or more of the terms included in (e.g., displayed on) the negotiation interface. This may result in the issuance (e.g., by the web client 106 or the programmatic client 108 of a client machine of the first or second user) of an instruction to modify at least a portion of the accessed terms. The negotiation module 206 may receive the instruction to modify at least a portion of the accessed terms and may generate a bundling agreement that includes the modified terms and the remaining accessed terms. The generated bundling agreement may be stored (e.g., by the negotiation module 206) and accessed in a record in the term database 214.

In some example embodiments, the negotiation module 206 is further configured to access (e.g., in the term database 214) a discount negotiated as part of the negotiation and to apply the discount to the price of the bundle of the first and second items. According to one example, the discount may be a reduction in price from the total price of the first and second items, which discount may be applied if the first and second items are purchased together. According to another example, the discount may be a reduction in price of the bundle price, which discount may be applied if the bundle is purchased within a predefined period of time.

A listing module 208 is configured to generate a bundle including the first identification of the first item and the second identification of the second item, based on the negotiation (e.g., the bundling agreement negotiated by the first and second users). The listing module 208 is further configured to generate a second listing including the first identification of the first item. In some example embodiments, a second listing generated by the listing module 208 may comprise the first identification of the first item but may not comprise the second identification of the second item provided by the second user. The listing module 208 may store the generated listings in the bundle database 216. The bundle database 216 may be accessed by one or more modules of the bundling component 200 to either retrieve or store data, or both.

In some example embodiments, the bundling agreement generated by the negotiation module 206 may govern two or more bundle listings. The first and second user may negotiate several different bundles of items. For example, two bundles may be negotiated as part of one negotiation: a first bundle including the first item provided by the first user and the second item provided by the second user, and a second bundle including a third item provided by the first user and a fourth item provided by the second user. The listing module 208 may generate bundle listings for the first and second bundles. Both bundle listings (for the first bundle and the second bundle) may be governed by one bundling agreement negotiated by the first and second users. This bundling agreement, in some example embodiments, may expire when both first and second bundles have been sold. According to another example, the first and second user may negotiate a long-term bundling agreement that may govern two or more bundle listings. In some example embodiments, such a long-term bundling agreement may not expire upon the sale of a last bundle governed by the long-term bundling agreement.

As described above, a recommendation module 210 is configured to recommend (e.g., to the first user) the subset of the one or more items. In some example embodiments, the first user may specify that only items available for bundling be recommended. In certain example embodiments, the first user may limit the recommendations to particular users (e.g., social network friends, family members, or reputable sellers).

A post-sale module 212 is configured to access a sales proceeds sharing term negotiated as part of the negotiation and determine a division of sales proceeds from the sale of a bundle of the first and second items based on the sales proceeds sharing term. For example, a sales proceeds sharing term may provide for a pro rata division of the sales proceeds based on the percentage that each of the items in the bundle contributes to the bundle price. In certain example embodiments, the sales proceeds sharing term may allocate a first amount of the proceeds to the first user, a second amount of the proceeds to the second user, and a third amount of the proceeds to the first user based on buyer behavior. For example, if, before clicking on an identification of the bundle of the first and second item, the buyer clicked on the identification of the first item (e.g., the buyer “arrived” at the bundle via the first item) rather than the identification of the second item, and if the buyer purchased the bundle, then the first user may be remunerated with the payment of a third amount.

Any two or more of these modules may be combined into a single module, and the functions described herein for a single module may be subdivided among multiple modules. Furthermore, according to certain example embodiments, the modules described herein as being implemented within a single machine, database, or device may be distributed across multiple machines, databases, or devices.

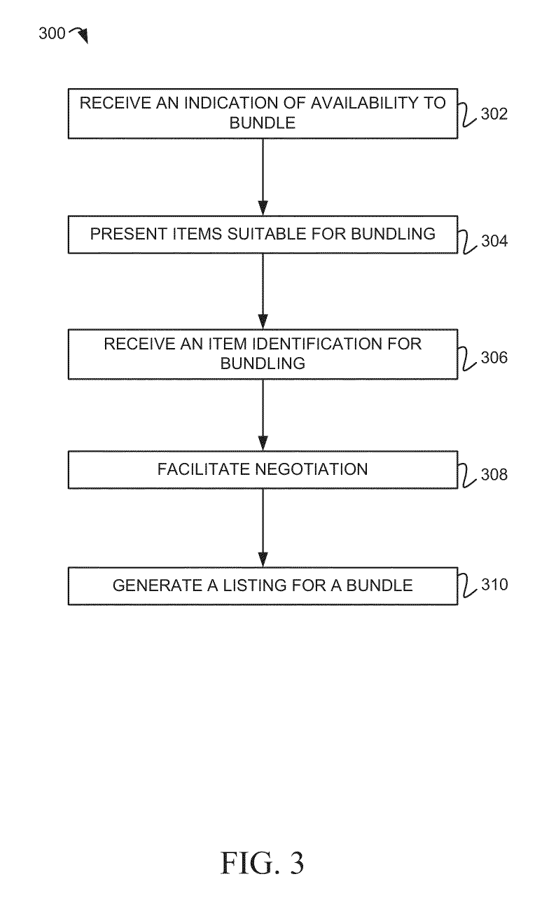

FIG. 3 is a flowchart illustrating an example of a collaborative bundling method, according to various example embodiments. The method 300 may be performed, in some example embodiments, by the bundling component 200.

In an operation 302, an indication of an availability to bundle is received. For example, the first user may indicate using a client device (e.g., client machine 110 or 112) that the first user's items (e.g., listed in an online marketplace) are available to be bundled with another user's items. In some example embodiments, the first user may identify (e.g., by clicking on an identifier of) a first item for sale in an online marketplace and indicate (e.g., by selecting a checkbox) that the first item is available to bundle with another user's item. The identification of the first item or the indication of availability to bundle, or both, may be received, in certain example embodiments, from a bot (e.g., a software application that may run an automated task on behalf of the first user) based on a predefined rule. The rule may be predefined by the first user. The identification of the first item or the indication of availability to bundle, or both, may be received, by the receiver module 202 of the bundling component 200.

In an operation 304, items suitable for bundling are presented. For example, one or more items suitable for bundling with the first item may be determined. The determination may be made by the selection module 204. Examples of factors that may be used in determining the one or more items suitable for bundling are historical sales data (e.g., what buyers tend to purchase together with the first item), items being part of a family of products (e.g., a photographic camera and lenses), items being accessories for a primary item (e.g., a memory card and a photographic camera), items enhancing other items (e.g., a frame and a piece of art, or a nail polish application and a manicure), and loss leaders. In certain example embodiments, a combination of factors may be used to determine the one or more items suitable for bundling with the first item. The selection of the factor(s) for the determination of the one or more items, in some example embodiments, may be performed automatically by the present system. In various example embodiments, the present system may base the selection of the factor(s) on knowledge about the first user's preferences (e.g., learned based on the first user's behaviour or provided by the first user).

Based on the indication of availability to bundle, an identification interface that presents identifications (e.g., names or descriptions) of the one or more items suitable for bundling with the first item are provided to the client device. The identification interface that presents the identifications of the one or more items suitable for bundling may be provided by the selection module 204.

In an operation 306, an item identification is received for bundling. In some example embodiments, a selection of a second identification of a second item may be received (e.g., by the selection module 204), which second identification may be selected from the identifications of the one or more items presented in the identification interface. The selection of the second identification may be received, for example, from the first user via the client device (e.g., client machine 110 or 112). In certain example embodiments, the selection of the second identification may be received at the receiver module 202 as a result of a software application executing on the client device.

In an operation 308, a negotiation is facilitated. The negotiation may be facilitated within the online marketplace (e.g., by the negotiation module 206) and may pertain to a bundling of the first and second items. In some example embodiments, the negotiation module 206 may provide a negotiation interface to the client devices (e.g., client machine 110 or 112) of the first and second users to be used during the negotiation. The negotiation interface, in certain example embodiments, may display terms included in a bundling agreement. The terms may be stored and accessed in a record in the term database 214. The terms may be part of a standard bundling agreement or may be offered by one of the users participating in the negotiation.

In an operation 310, a listing for a bundle is generated. Based on the negotiation, a bundle listing, including the first identification of the first item and the second identification of the second item, may be generated (e.g., by the listing module 208). The bundle listing may be stored (e.g., by the listing module 208) and accessed in a record in the bundle database 216. The bundle listing may be published (e.g., by the listing module 208) in a catalogue of items for sale using the online marketplace.

FIGS. 4A and 4B are example portions of user interfaces for collaborative bundling, according to various example embodiments. FIG. 4A illustrates, for example, a portion of an identification interface 400 that welcomes the first user and displays an “Item to list for sale” drop-down list and an “Available for bundling” drop-down list. The drop-down lists may be activated by clicking on the black triangle located at the right end of each of the drop-down list. The identification interface 400 may allow the first user to select the identification “Camera XYZ—$100” of the “Camera XYZ” first item in the “item to list for sale” drop-down list. Also, the identification interface 400 may allow the first user to indicate that the “Camera XYZ” first item is available for bundling by selecting the “Yes” option in the “Available for bundling” drop-down list. When the “Camera XYZ” first item is selected, an image and the name of the “Camera XYZ” first item may be displayed (e.g., by the selection module 204).

FIG. 4B depicts, for example, a portion of an identification interface 410 that presents items suitable for bundling with the first item. In some example embodiments, the identification interface 410 may display the image and name of the “Camera XYZ” first item, an “Item with which to bundle” drop-down list, and an “Available for bundling” drop-down list. The first user may activate the “Item with which to bundle” drop-down list by clicking on the black triangle situated at the right end of the “item with which to bundle” drop-down list. Activating the “Item with which to bundle” drop-down list may allow the first user to see a list of identifications of one or more items suitable for bundling with the first item “Camera XYZ”. The first user may select a second identification of a second item from the identifications of the one or more items displayed in the activated “Item with which to bundle” drop-down list. In some example embodiments, the first user may request that the identifications of the one or more items suitable for bundling be filtered (e.g., by the selection module 204) according to a criterion displayed in the activated “Available for bundling” drop-down list. For example, by choosing the “Yes” option in the activated “Available for bundling” drop-down list, the first user may request that the one or more items whose identifications are displayed in the identification interface (e.g., in the “Item with which to bundle” drop-down list) be available for bundling. In another example, by selecting the “Unknown. Send invite to bundle” option, the first user may request that the present system filters the one or more items based on an unknown availability for bundling and transmits an invitation to negotiate a bundle to the users who provided the identifications for the items with unknown availability for bundling.

FIG. 5 is an example portion of a user interface for collaborative bundling, according to various example embodiments. FIG. 5 illustrates, for example, a portion of the identification interface 500 including the image and name of the “Camera XYZ” first item, an “Item with which to bundle” drop-down list, and an “Available for bundling” drop-down list. The identification interface 500 depicts the selection of the “16 GB SD Card—$20” second identifier of the “16 GB SD Card” second item. In some example embodiments, the selection is made by the first user based on the identifications of one or more items suitable fir bundling with the first item, as described with reference to FIGS. 4A and 4B.

FIG. 6 is an example portion of a user interface for negotiation of terms during a collaborative bundling process, according to various example embodiments. As illustrated, for example, in FIG. 6, a negotiation interface 600 may be presented to the first and second users to facilitate a negotiation within the online marketplace, which negotiation may pertain to a bundling of the first and second items. In some example embodiments, the negotiation interface 600 may be displayed to the first and second users based on the first user selecting the second identification of the second item, which second item is listed as available for bundling (e.g., in the “Available for bundling” drop-down list, as described with respect to FIG. 4B). In certain example embodiments, the negotiation interface 600 may be displayed to the first and second users based on the second user replying to an invitation to negotiate a bundle of the first and second items. The invitation may be sent to the second user when the availability for bundling status of the selected second item is unknown, as described with respect to FIG. 4B. In some example embodiments, the negotiation interface may include the image and name of the “Camera XYZ” first item, an indication that the “Camera XYZ” first item is sold by the first user, the name of the “16 GB SD Card” second item, an indication that the “16 GB SD Card” second item is sold by the second user, a first user window 604 and a second user window 606 to allow the first and second users to see their communication (e.g., an exchange of messages between the first and second users). As depicted, for example, in FIG. 6, the first and second users may negotiate bundling terms such as a discount of the price of the bundle, the splitting of the shipping cost (e.g., the shipping fee), and the division of the sales proceeds of the bundle. The negotiated terms may be stored and accessed in a record in the term database 214. Further, the negotiated bundle of the first and second items may be stored and accessed in a record in the bundle database 216.

FIG. 7 is an example portion of a user interface for negotiation of terms during a collaborative bundling process, according to various example embodiments. As illustrated, for example, in FIG. 7, a negotiation interface 700 may be presented to the first and second users to facilitate a negotiation within the online marketplace, which negotiation may pertain to a bundling of the first and second items. In some example embodiments, the negotiation interface 700 may be displayed to the first and second users based on the first user selecting the second identification of the second item, which second item is listed as available for bundling (e.g., in the “Available for bundling” drop-down list, as described with respect to FIG. 4B). In certain example embodiments, the negotiation interface 700 may be displayed to the first and second users based on the second user replying to an invitation to negotiate a bundle of the first and second items. The invitation may be sent to the second user when the availability for bundling status of the selected second item is unknown, as described with respect to FIG. 4B. In some example embodiments, the negotiation interface may include the image and name of the “Camera XYZ” first item, an indication that the “Camera XYZ” first item is sold by the first user, the name of the “16 GB SD Card” second item, an indication that the “16 GB SD Card” second item is sold by the second user, a drop-down list inquiring about suggested bundling agreement terms, a list of suggested terms that may be chosen or modified (or both), a first user window 604, and a second user window 606 to allow the first and second users to see their communication (e.g., an exchange of messages between the first and second users). In one example depicted in FIG. 7, the first user may select the “Yes” option in the drop-down list. Based on the selected “Yes” option, the negotiation module 206 may display a list of suggested terms (e.g., 10% discount, free shipping, 30-day return, and warranty). Each of the suggested terms may be modifiable. For example, the first user may click on the “modify” button to the right of the “10% discount” term to modify the suggested discount to “15%”. The first user may similarly modify the “30-day return” term to “60-day return”. Each modified term may be tagged and displayed with the name of the user who modified the respective term, as shown in FIG. 7. In certain example embodiments, the negotiation module 206 may communicate the modified terms (e.g., 15% discount and 60-day return) to the second user by displaying them in the first user window 704. The first user window 704 and the second user window 706 may allow the first and second user to communicate during the negotiation of the bundling terms (e.g., by exchanging messages). In some alternative example embodiments, the negotiation interface 700 may allow the second user to see the first user's actions using the negotiation interface 700 (e.g., selecting and modifying suggested terms).

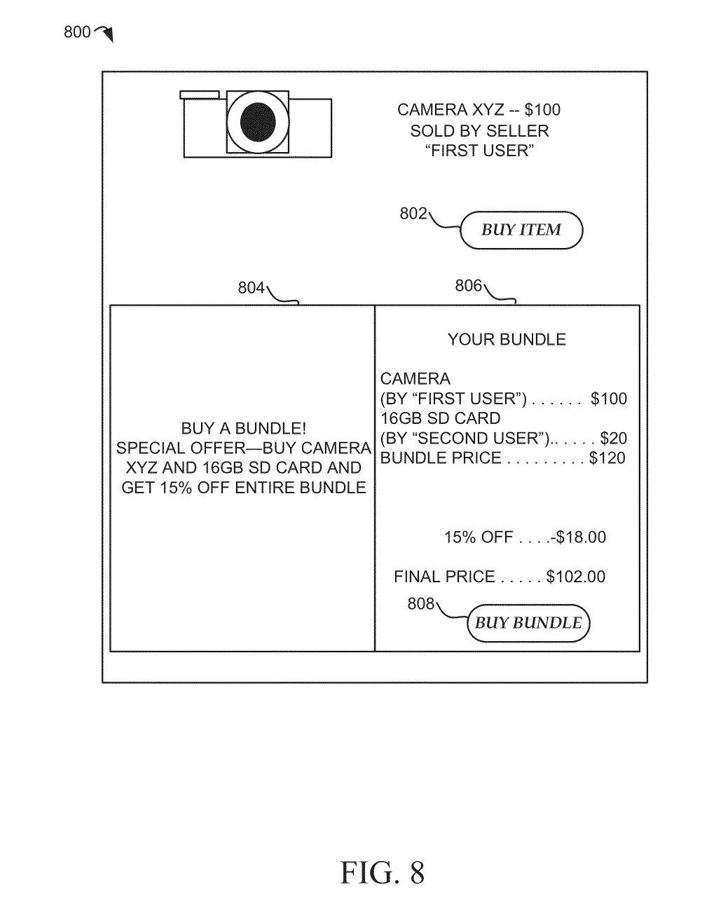

FIG. 8 is an example portion of a user interface for providing a collaborative bundle, according to various example embodiments. The interface 800 may include, for example, the image and name of the “Camera XYZ” first item, an indication that the “Camera XYZ” first item is sold by the first user, and an option 802 to purchase the “Camera XYZ” first item without purchasing additional (e.g., bundled) items. A bundle interface 804 includes an indication that a buyer receives a 15% discount if the buyer purchases the “Camera XYZ” first item and the “16 GB SD Card” second item as a bundle. A buying interface 806 displays a list of the items that make up the bundle (e.g., the “Camera XYZ” first item and the “16 GB SD Card” second item). Also shown in the buying interface are the names of the sellers of the respective bundle items (e.g., the first and second users). The data displayed in the buying interface 806 may be updated in response to the buyer adding items to or removing items from the bundle. The buying interface 806 may also display the discount applied to the bundle price. If the buyer adds a third item to the bundle, a further discount may be applicable and applied to the bundle price. The data displayed in the buying interface 806 may be updated based on the application of the further discount. A buyer may purchase the bundle of the first and second items by selecting the option 808 to purchase the bundle.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

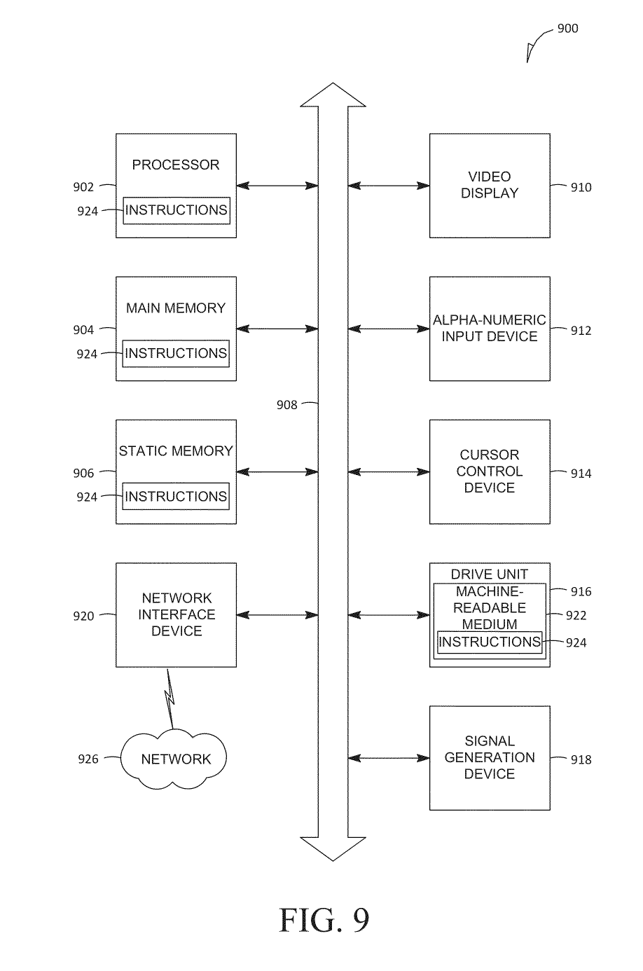

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a cursor control device 914 (e.g., a mouse), a drive unit 916, a signal generation device 918 (e.g., a speaker) and a network interface device 920.

### Machine-Readable Medium

The drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network. 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a receiver module configured to receive from a client device a first identification of a first item for sale in an online marketplace and an indication of availability to bundle;
a selection module configured to:
based on the indication of availability to bundle, provide to the client device an identification interface that presents identifications of one or more items suitable for bundling with the first item, and
receive a selection of a second identification of a second item, the second identification selected from the identifications of the one or more items;
a negotiation module configured to facilitate a negotiation within the online marketplace pertaining to a bundling of the first and second items; and
a listing module configured to generate, using one or more processors, a bundle listing including the first identification of the first item and the second identification of the second item, based on the negotiation.

2. The system of claim 1, wherein
the selection module is further configured to determine a subset of the one or more items that are suitable for bundling with the first item fir sale; and further comprising:
a recommendation module configured to recommend the subset of the one or more items.

3. The system of claim 2, wherein the subset is determined based on a reputation of one or more users.

4. The system of claim 2, wherein the subset is determined based on one or more bundle definitions.

5. The system of claim 2, wherein the subset is determined based on a respective one or more items being listed for sale beyond a time threshold.

6. The system of claim 1, wherein
the selection module is further configured to receive a ranking of the one or more identifications, the ranking indicating a preferred bundling order.

7. The system of claim 1, wherein
the selection module is further configured to receive a ranking of preferred bundling partners.

8. The system of claim 1, wherein
the listing module is further configured to generate a second listing including the first identification of the first item.

9. The system of claim 1, wherein
the negotiation module is further configured to transmit an invitation to negotiate a bundle of the first and second items.

10. The system of claim 1, wherein the negotiation module is further configured to:
based on receiving an instruction to initiate the negotiation, access terms included in a bundling agreement;
provide a negotiation interface including the accessed terms;
receive an instruction to modify at least a portion of the accessed terms; and
generate a bundling agreement including the modified terms and the remaining accessed terms.

11. The system of claim 8, wherein the bundling agreement governs two or more bundle listings.

12. The system of claim 1, wherein the negotiation module is further configured to:
access a discount negotiated as part of the negotiation, and
apply the discount to a price of a bundle of the first and second items.

13. The system of claim 1, further comprising:
a post-sale module configured to:
access a sales proceeds sharing term negotiated as part of the negotiation, and
determine a division of sales proceeds from a sale of a bundle of the first and second items based on the sales proceeds sharing term.

14. The system of claim 11, wherein the sales proceeds sharing term allocates a first amount of the proceeds to a first user, a second amount of the proceeds to a second user, and a third amount of the proceeds to the first user based on buyer behavior.

15. A method comprising:
receiving from a client device a first identification of a first item for sale in an online marketplace and an indication of availability to bundle;
based on the indication of availability to bundle, providing to the client device an identification interface that presents identifications of one or more items suitable for bundling with the first item;
receiving a selection of a second identification of a second item, the second identification selected from the identifications of the one or more items;
facilitating a negotiation within the online marketplace pertaining to a bundling of the first and second items; and
generating, using one or more processors, a bundle listing including the first identification of the first item and the second identification of the second item, based on the negotiation.

16. The method of claim 14, further comprising:
determining a subset of the one or more items that are suitable for bundling with the first item for sale; and
recommending the subset of the one or more items.

17. The method of claim 14, wherein the facilitating a negotiation further comprises:
transmitting an invitation to negotiate a bundle of the first and second items.

18. The method of claim 14, wherein the facilitating a negotiation further comprises:
based on receiving an instruction to initiate the negotiation, accessing terms included in a bundling agreement;
providing a negotiation interface including the accessed terms;
receiving an instruction to modify at least a portion of the accessed terms; and
generating a bundling agreement including the modified terms and the remaining accessed terms.

19. The method of claim 14, further comprising:
accessing a sales proceeds sharing term negotiated as part of the negotiation; and
determining a division of sales proceeds from a sale of a bundle of the first and second items based on the sales proceeds sharing term.

20. A non-transitory machine-readable medium having instructions embodied thereon, the instructions executable by one or more processors to perform operations comprising:
receiving from a client device a first identification of a first item for sale in an online marketplace and an indication of availability to bundle;
based on the indication of availability to bundle, providing to the client device an identification interface that presents identifications of one or more items suitable for bundling with the first item;
receiving a selection of a second identification of a second item, the second identification selected from the identifications of the one or more items;
facilitating a negotiation within the online marketplace pertaining to a bundling of the first and second items; and
generating, using one or more processors, a bundle listing including the first identification of the first item and the second identification of the second item, based on the negotiation.
